(19) United States
(12) Patent Application Publication
(10) Pub. No.: US 2013/0157024 A1
(43) Pub. Date: Jun. 20, 2013

(54) COATING CONTAINING PEK AND/OR PEEK

(71) Applicant: Rhenotherm Kunststoffbeschichtungs GmbH, Kempen (DE)

(72) Inventor: Volkmar Eigenbrod, Krefeld (DE)

(73) Assignee: Rhenotherm Kunststoffbeschichtungs GmbH, Kempen (DE)

(21) Appl. No.: 13/690,116

(22) Filed: Nov. 30, 2012

(30) Foreign Application Priority Data
Nov. 30, 2011 (DE) 102011119731.5

(51) Int. Cl. C09D 171/00; C09D 185/00; C09D 177/00

(52) U.S. Cl. CPC C09D 171/00; C09D 177/00; C09D 185/00
USPC 428/215; 428/422; 524/540; 524/443; 524/430; 524/539; 252/500

(57) ABSTRACT

The invention concerns a non-stick coating for a substrate consisting of a metallic material, glass, ceramic, stone or enamel, which is characterised by at least one layer applied directly to the substrate and consisting of at least 33 wt. % polyetherketone and/or polyetheretherketone (PEEK), at least 33 wt. % of one or more fluoropolymers and no more than 16 wt. % additives.

The invention concerns a non-stick coating for a substrate consisting of a metallic material, glass, ceramic, stone or enamel, the non-stick coating comprising at least one first layer applied directly to the substrate. The invention also concerns work pieces coated with a non-stick coating.

A non-stick coating in the framework of the present invention is taken to mean a coating which is such that it is particularly suitable for sheets, rollers or other machine parts in the food, adhesive, rubber or paint-processing industry. Good non-stick properties are particularly relevant where specific surface regions have the property that adhesive, adhesive comprising media or sticky media like e.g. labels, adhesive tapes or food, do not adhere there.

U.S. Pat. No. 6,596,380 B1 discloses a non-stick coating. To improve the adhesion of the non-stick coating to a substrate, it is proposed to provide a three-layer construction comprising a lower layer, a main layer and an upper layer. The lower layer consists of at least 50 wt. % polyetheretherketone (PEEK, oxy-1.4-phenylene-oxy-1.4-phenylene-carbonyl-1.4-phenylene) and is free from fluorine-containing polymers. The main layer contains fluorine-containing polymers as well as proportions of temperature-stable polymers such as PEEK. The upper layer consists substantially of fluorine-containing polymers.

DE 600 07 853 T2 discloses a very similar non-stick coating with a lower layer, a primer layer containing a fluoroplastic and at least one cover layer based on a fluoroplastic, wherein the scratch resistance is improved by the use of a lower layer substantially consisting of PEEK. The lower layer is discontinuous, forms a matrix and essentially consists exclusively of PEEK.

Also patent specification DE 10 2005 004 829 B4 discloses an article with a coating comprising at least one upper cover layer and one lower layer below this. Both layers comprise high performance thermoplastics selected from the group of polyaryletherketones, LCP, PEK, PEEK, PPS and mixtures thereof. The cover layer also comprises 20-30% thermoplastic organic fluoropolymers.

The object of the invention is to provide a non-stick coating of the type cited initially which in comparison with the prior art has an improved combination of properties in relation to scratch resistance, temperature resistance, impermeability to water vapour and corrosion resistance.

This object is achieved, in a non-stick coating of the type cited initially and a workpiece coated therewith, by a first layer to be applied directly to the substrate and consisting of at least 30 wt. % polyetherketone and/or polyetheretherketone (PEEK), at least 33 wt. % of one or more fluoropolymers and no more than 16 wt. % additives.

The special feature of this non-stick coating is that the PEK or PEEK of the first layer forms a matrix structure which firstly connects extremely well with the substrate and in which secondly the fluoropolymer(s) and any additives are embedded. The fluoropolymer(s) therefore are not only themselves bonded to the substrate but they are also held in a matrix structure so that they are connected very firmly with the substrate. The result is an extremely scratch-resistant structure which because of the embedded fluoropolymer has good non-stick properties. The combination of high scratch resistance and good n n-stick properties exists even at comparatively high temperatures, since PEK or PEEK has a considerably better temperature resistance than fluoropolymers and the fluoropolymer(s) are also fixed in the matrix structure at temperatures for example of over 260° C., at which without matrix structure they would lose their fixed connection to the substrate.

Substrates suitable for coating are above all materials which survive a sintering temperature of 400° C. and more without oxidation or decomposition, such as in particular metal substrates (for example iron, steel, aluminium and their alloys), glass, ceramic or stone.

Whether PEEK or PEK is used, or where applicable a mixture of the two, depends substantially on the application of the non-stick coating. Whereas PEEK is easier to work, PEK has a higher heat resistance.

In a preferred embodiment the non-stick coating comprises at least 50 wt. % PEK and/or PEEK in the first layer.

In another preferred embodiment the non-stick coating comprises more than 40 wt. %, and in a further embodiment more than 45 wt. % of a fluoropolymer or a mixture of several fluoropolymers.

In a further preferred embodiment the proportion of additives in the non-stick coating is no more than 10 wt. %. The additives comprise preferably in particular one or more colour pigments, in particular with a proportion of 1 to 4 wt. % in relation to the layer, in particular if the layer is the colouring layer or one of the colouring layers of the non-stick coating.

In addition as additives inorganic substances can be considered, in particular glass fibres, glass flakes, carbon fibres, carbon or graphite in the form of particles, SiC, AL₂O₃, MoS₂ or SO₂ or mixtures thereof, preferably with a proportion of 2 to 8 wt. % in relation to the layer.

The friction coefficient of PEEK or PEK to steel is around 0.17. The friction coefficient to steel can be reduced to 0.11 by the addition for example of graphite and/or molybdenum disulphate in weight proportions of less than 10 wt. %. In particular then the non-stick coating according to the invention also fulfils tribological purposes. It can for example be used for coating bearing surfaces. The non-stick coating can be formed optionally as a single-layer coating system or as a multi-layer system. In a multi-layer system at least the top cover layer, preferably all layers, meets the requirements for composition of the first layer and at least the cover layer contains the friction-reducing additives. The particular advantage is that bearing surfaces coated in this way are extremely abrasion-resistant and hence comparatively wear-resistant. The non-stick coating is suitable in particular for coating bearing surfaces under high mechanical and/or thermal stress.

Also organic substances, in particular PPSO₂ or aramide, can be used as additives, in particular with a proportion of 2 to 8 wt. % in relation to the layer.

Additives such as SiC, Al₂O₃, SiO₂ can be used to increase the hardness of the non-stick coating. In particular carbon fibres and glass fibres or flakes are used amongst others to absorb stresses in the non-stick coating which occur on cooling, i.e. on transition from the gel-like or liquid state to the crystalline state. The length of carbon or glass fibres preferably used is preferably 5 to 500 μm for a fibre diameter of preferably 5 to 20 μm. The fibres help prevent stress cracks in the non-stick coating which could lead to so-called stress crack corrosion.

To create an electrically conductive non-stick coating, electrically conductive inorganic fibres can be contained in the non-stick coating as additives, preferably in a proportion of 5 to 9 wt. % in relation to the layer. For a layer-related proportion of 7 wt. % for example a surface resistance of <10⁶Ω can be produced.

As fluoropolymer portion of the first layer, the fluoropolymers polytetrafluoroethylene (PTFE), polyfluoralkoxylalkane (PFA), tetrafluoroethylene perfluoromethylvinylether (MFA) or tetrafluoroethylene hexafluoropropylene (FEP) or a mixture thereof can be used, wherein in particular PFA and FEP are preferred.

The grain sizes of PEEK and PEK to produce the first layer preferably lie between 2 and 100 μm. The grain sizes of the fluoropolymers in the use of powder preferably lie also between 2 to 100 μm, and in the use of dispersions between 100 nm and 5 μm.

In a preferred embodiment the non-stick coating can consist exclusively of the first layer. If the non-stick coating is designed thicker, it can be multi-layered, wherein the layers applied to the first layer can have the same composition as the first layer.

The first layer is however also ideally suitable as a primer for multi-layer non-stick coatings in which the second layer adjacent to the first layer contains at least one fluoropolymer but is free from PEK or PEEK. In such non-stick coatings it can be preferred if the coating has two layers so that the second layer forms the top layer.

When used as a primer, the first layer preferably can be used as a base layer for dispersion coatings of fluoropolymers such as PTFE, PFA, MFA and/or FEP. In particular it is suitable for use as a primer for powder coatings of PFA, MFA and/or FEP.

The abovementioned preferred grain sizes of fluoropolymers apply both to the production of the primer and for further layers lying above this which contain the fluoropolymers.

The thickness of the first layer as an individual layer is preferably between 5 and 100 μm, the thickness of a non-stick coating according to the invention consisting of several layers is preferably up to 2000 μm.

In particular with so-called fluoropolymer thick layer systems, the thickness of which is preferably 500 to 2000 μm, the first layer according to the invention of the non-stick coating is of very particular advantage as a primer for its stability. In the production of the coating the primer is exposed to very intensive heat load cycles. In the production of multi-layer coating systems, layers are applied repeatedly which respectively fuse together at 330° C. to 420° C. Preferred temperature ranges for the layer(s) containing PEEK or PEK are 380° C. to 420° C. (particularly preferred temperature around 400° C.) and for further fluoropolymer layers 360° C. to 420° C. For thick layers of 2000 μm, this can be repeated up to 15 times.

The application of the first and all further layers can take place for example in the form of a dispersion, preferably on an unheated substrate. The first and all further layers can also be applied in the form of a powder, wherein the part to be coated can then also be hot. The powdery coating mixture can be applied for example with an electrostatic powder gun. Also so-called hot flocking can be used as a method for applying the layer(s).

The non-stick coating according to the invention is particularly suitable for coating work pieces having a surface to be coated which consists of a metallic material, glass, ceramic, stone or enamel.

With the coating according to the invention a very hard non-stick coating is provided which has an improved scratch resistance and a significantly better thermal resistance than other fluoropolymer coatings. The coating can even briefly resist usage temperatures up to 340° C. or even more. In addition it has significant advantages compared with known non-stick coatings, i.e. particular improved corrosion resistance, above all because of a better impermeability to water vapour. The coating according to the invention is also chemically very resistant and has a high hardness.

The invention is now described below with reference to figures showing preferred embodiments of the invention. These show:

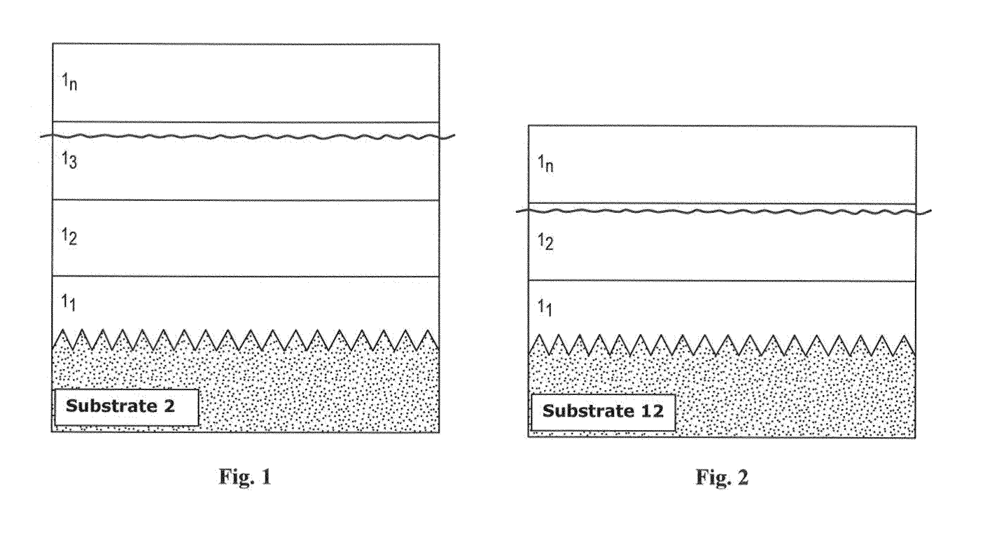

FIG. 1 a sketched layer structure of a multi-layer non-stick coating according to the invention with different layer compositions;

FIG. 2 a sketched layer structure of a single-layer or multi-layer non-stick coating according to the invention with uniform layer composition; and

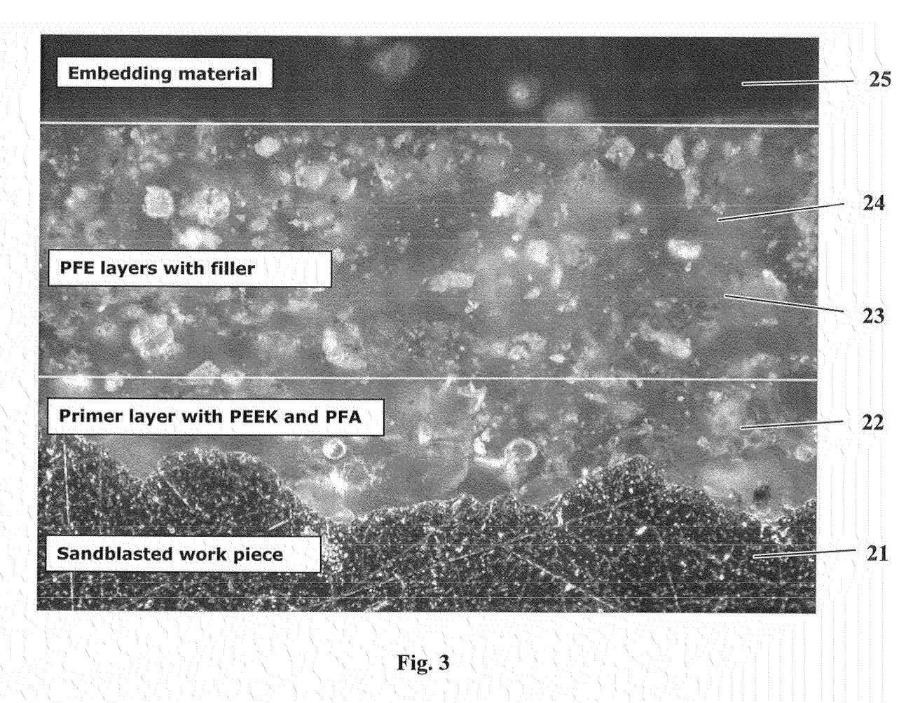

FIG. 3 a micrograph of a non-stick coating according to the invention.

FIG. 1 show a sketch of a non-stick coating which consists of different layers 1₁ to 1ₙ lying above each other on a metal substrate 2. The bottom layer 1₁ consists of a mixture according to the invention of PEEK and/or PEK with one or more fluoropolymers selected from the group of PTFE, PFA, MFA and FEP. The layer can contain various additives as required. It lies directly on the metal substrate and is firmly connected therewith. The layer is applied to the substrate optionally as a dispersion or as powder and then sintered at 360° C. to 420° C. The resulting layer thickness is preferably 10 to 50 μm. The first layer serves as a so-called primer for the layers above this.

Layers 1₂, 1₃, . . . 1ₙ (n preferably ≦15) lying above also contain one or more fluoropolymers of the said group but are free from PEEK and PEK. They are applied successively to the respective layer below which is preferably cooled. The layer thickness can be up to 2000 μm.

The non-stick coating sketched in FIG. 2 differs from the coating described above firstly in that all layers 11₁ to 11ₙ, contain PEK and/or PEEK and correspond to the criteria according to the invention for the composition of the first layer. Preferably the composition of all layers is the same. The layer thickness of the layers is preferably 10 to 100 μm. The number n of layers is preferably ≦10, the layer thickness preferably ≦400 μm.

FIG. 3 shows a micrograph of a three-layer coating system according to the invention on a sandblasted workpiece. The bottom layer in direct contact with the workpiece 21 is a primer layer 22 containing PEEK and PFA. Applied onto this are two PFA layers 23, 24 containing filler. After each layer application, the applied layer is sintered to the layer below so that no clear layer boundaries can be seen. The entire thickness of the non-stick coating is around 100 μm. Above the two PFA layers may be seen an embedding material 25 which is not part of the coating but would be used to produce a clear micrograph.

### EXAMPLE

To clarify the advantages of the invention, pretzel breadstick baking sheets were coated with non-stick coatings according to the invention and with a coating not according to the invention, and compared. Before application of the non-stick coating the sheets to be coated were degreased and then sandblasted (e.g. with aluminium corundum FEPA 60, grain size 210 to 297 μm).

The non-stick coating according to the invention has a three-layer structure with a first primer layer applied to the pretzel breadstick baking sheet and two commercial PFA coatings arranged thereon. The primer layer was produced from a mixture of two parts of a PEEK dispersion and one part of PFA dispersion. The PEEK dispersion used was the commercially available dispersion known as Vicote® F804 by Victrex plc, and the PFA dispersion was the coating available under reference 857N-110 from DuPont. Colour pigments were added to the mixture. The mixture was applied to the pretzel breadstick baking sheet then dried in air for around 5 minutes, oven-dried at around 120° C. for a further 5 minutes and then sintered at 380° C. to 400° C. until the coating appeared smooth and glossy. The primer layer produced contained 66 wt. % PEEK, 33 wt, % PFA and 1% filler (pigments).

Then two cover layers were applied of a commercial PFA dispersion available under reference 857N-110 by DuPont, and dried and sintered in the same way as the primer layer.

All layers were applied by spraying, wherein the layer thickness for the primer layer lay in the range of 20 to 40 μm and the layer thickness for the cover layer in total lay in a range from 40 to 50 μm.

The pretzel breadstick baking sheet was used experimentally for industrial pretzel breadstick production. The service life of the pretzel breadstick baking sheet was more than 3 months.

In the same way, further pretzel breadstick baking sheets were coated with a non-stick coating according to the invention, the only difference being in that the primer layer of some of the pretzel breadstick baking sheets comprised 57 wt. % PEEK, 42 wt. % PFA and 1% wt. % filler and that the primer layer of the other pretzel breadstick baking sheets comprised 52 wt. % PEEK, 47 wt. % PFA and 1 wt. % filler.

It was observed that the service life of the pretzel breadstick baking sheet increased the higher the PFA portion of the primer layer was. This seems to be attributable to an increase of the bond strength between the primer layer and the cover layers due to the increasing amount of PFA in the primer layer.

A further pretzel breadstick baking sheet was coated with a two-layer system of a conventional fluoropolymer coating in which the layer applied to the baking sheet consisted of a dispersion of reference 420N-703 by DuPont and the second layer applied thereon was a PFA dispersion reference 858N-917 Ruby Red by DuPont. The sintering temperatures and durations were the same as those of the PFA layers of the coating according to the invention and the total layer thickness was around 60 μm.

This pretzel breadstick baking sheet was also used experimentally for industrial lye production. The service life of the tray was six weeks, after which large areas of the coating became detached due to corrosion of the metal baking sheet. Clearly the barrier effect of the coating was not sufficiently high against attack from the lyes used during baking.

1. A non-stick coating for a substrate consisting of a metallic material, glass, ceramic, stone or enamel, the non-stick coating comprising at least one first layer applied directly to the substrate and consisting of at least 33 wt. % polyetherketone and/or polyetheretherketone (PEEK), at least 33 wt. % of one or more fluoropolymers and no more than 16 wt. % additives.

2. The non-stick coating according to claim 1, wherein the at least one first layer includes at least 50 wt. % PEK and/or PEEK.

3. The non-stick coating according to claim 1, wherein the at least one first layer includes more than 40 wt. % of one or more fluoropolymers.

4. The non-stick coating according to claim 1, wherein the proportion of additive does not exceed 10 wt. %.

5. The non-stick coating according to claim 1, the additives comprise one or more colour pigments.

6. The non-stick coating according to claim 1, wherein the additives comprise inorganic substances.

7. The non-stick coating according to claim 1, wherein the additives comprise organic substances.

8. The non-stick coating according to claim 1, wherein the at least one first layer includes electrically conductive inorganic fibres with a proportion of 5 to 9 wt. % in relation to the at least one first layer.

9. The non-stick coating according to claim 1, wherein the one or more fluoropolymers are selected from the group consisting of PTFE, PFA, MFA and FEP.

10. The non-stick coating according to claim 1, wherein the coating consists exclusively of the at least one first layer.

11. The non-stick coating according to claim 1, wherein the non-stick coating has multiple layers, wherein one or more layers applied to a first layer have the same composition as the first layer.

12. The non-stick coating according to claim 1, wherein the non-stick coating has multiple layers, and wherein a second layer adjacent to a first layer contains at least one fluoropolymer which is free from PEK or PEEK.

13. The non-stick coating according to claim 12, wherein the second layer is the top of the coating.

14. The non-stick coating according to claim 1, wherein the non-stick coating has a first layer thickness of 5 to 100 μm and/or a total coating thickness of not more than 2,000 μm.

15. A work piece with the non-stick coating according to claim 1, wherein the substrate on which the non-stick coating is applied consists of a metallic material, glass, ceramic, stone or enamel.

16. The non-stick coating according to claim 3, wherein the at least one first layer includes more than 45 wt. % of one or more fluoropolymers.

17. The non-stick coating according to claim 6, wherein the inorganic substances include one or more of glass fibres, glass flakes, carbon fibres, carbon in the form of particles, SiC, Al₂O₃ or SiO₂ or mixtures thereof, and wherein the inorganic substances have a proportion of 2 to 8 wt. % in relation to the at least one first layer.

18. The non-stick coating according to claim 7, wherein the organic substances include one or more of PPSO₂ or aramide, and wherein the organic substances have a proportion of 2 to 8 wt. % relation to the at least one first layer.
